(19) United States
(12) Patent Application Publication
(10) Pub. No.: US 2007/0289920 A1
(43) Pub. Date: Dec. 20, 2007

(54) POOL AND SPA FILTER

(75) Inventors: John Frank Baker JR., Nashville, TN (US); John M. Reeves, Franklin, TN (US); Shannon Schoppman, Nashville, TN (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Fiberweb, Inc.

(21) Appl. No.: 11/748,178

(22) Filed: May 14, 2007

Related U.S. Application Data
(60) Provisional application No. 60/747,116, filed on May 12, 2006.

(51) Int. Cl. B01D 33/00; B32B 5/26; B32B 7/00

(52) U.S. Cl. 210/505; 428/219; 442/346; 442/382

(57) ABSTRACT

A filter cartridge comprises a filter medium including a plurality of layers of a spunbond nonwoven fabric of continuous filaments. The filter medium may also include one or more additional layers such as a thermal or resin bonded carded nonwoven fabric, a hydroentangled nonwoven fabric or a fabric formed from caustic cotton fibers. The filter medium is formed into a pleated configuration. The filter medium may suitably comprise from 2 to 15 layers of the nonwoven fabric that are bonded to one another to form a relatively stiff multi-layer structure. The overall thickness of the filter medium is preferably from 0.25 to 3 mm.

### BACKGROUND OF THE INVENTION

The present invention relates to filtration, and more particularly to a filtration medium and liquid filter for use in pool and spa filters.

Pools and spas typically include a filtration system through which the water is circulated to remove dirt, debris and other foreign matter. Many of the filtration systems utilize a replaceable filter cartridge of a generally cylindrical form containing a filter element of a pleated construction. The filter element is typically made of a pleated polyester nonwoven fabric material. One such nonwoven fabric material that has been in widespread use for a number of years is sold by BBA Fiberweb under the trademark Reemay® and comprises a spunbond nonwoven fabric formed of polyester filaments bonded together to form a coherent strong pleatable nonwoven fabric filtration medium.

It is typical for the filter cartridge to be removed periodically from the filtration system and cleaned, by rinsing with a garden hose, to remove accumulated dirt and debris trapped by the filter. Then the filter cartridge is replaced in the filtration system. This approach is labor intensive, and can result in poor filtration efficiency if the filter cartridge is reused too many times.

### BRIEF SUMMARY OF THE INVENTION

The present invention provides a filtration medium and a filter cartridge for pools and spas that has high filtration efficiency and is produced from low cost materials that allow for the filter cartridge to be a single-use filter that is disposed of when dirty and replaced with a new filter cartridge, rather than being cleaned and reused.

According to the present invention, the filter cartridge comprises a filter medium including a plurality of layers of a spunbond nonwoven fabric of continuous filaments. The filter medium may also include one or more additional layers such as a thermal or resin bonded carded nonwoven fabric, a hydroentangled nonwoven fabric or a fabric formed from caustic cotton fibers. The filter medium is formed into a pleated configuration. The filter medium may suitably comprise from 2 to 15 layers of the nonwoven fabric that are bonded to one another to form a relatively stiff multi-layer structure. The overall thickness of the filter medium is preferably from 0.25 to 3 mm.

In one advantageous embodiment of the invention, the filter cartridge includes a filter medium in the form of a plurality of layers of a composite nonwoven fabric laminate, wherein the laminate includes at least one spunbond layer and at least one additional nonwoven fabric layer. The layers of composite nonwoven fabric laminate are bonded together and formed into a pleated configuration.

In a more specific embodiment, the composite nonwoven fabric used in the filter medium is a spunbond-meltblown-spunbond (SMS) composite nonwoven fabric including outer spunbond layers formed of continuous filaments bonded to one another to form a spunbond nonwoven fabric and at least one interior layer of meltblown fibers between said outer spunbond layers. Each composite nonwoven fabric layer preferably has a basis weight of from 10 to 100 grams per square meter (gsm).

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a filter cartridge;

FIG. 2 is a cross-sectional view thereof taken substantially along the line 2-2 of FIG. 1;

FIG. 3 is a schematic cross-sectional view of a filtration medium comprised of multiple layers of a spunbond nonwoven fabric in accordance with one embodiment of the invention; and

FIG. 4 is a schematic cross-sectional view of a filtration medium comprised of multiple layers of a spunbond-meltblown-spunbond composite nonwoven fabric laminate in accordance with another embodiment of the invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

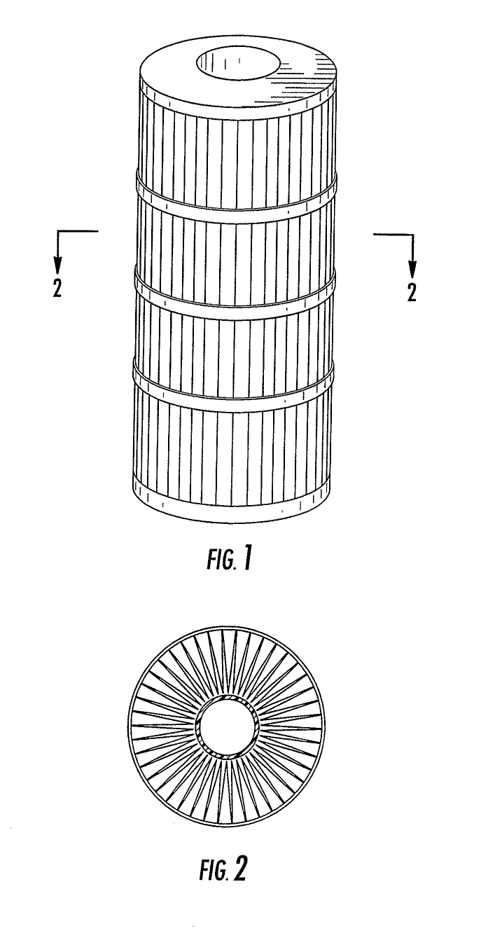

A filter cartridge of the type commonly used spa and pool filters is shown in FIG. 1. The filter cartridge includes end caps 11, 12 and a filter element 13 mounted between the end caps. The filter element 13 is of a generally cylindrical configuration and is of a pleated construction. More particularly, as best seen in FIG. 2, the filter element 13 is formed by a filtration medium 20 which has been pleated along parallel pleat lines or folds 15 that extend parallel to the longitudinal axis of the cylindrical filter element. The pleated construction of the filter element 13 provides for the exposure of a large surface area of the filtration medium to the flow of water.

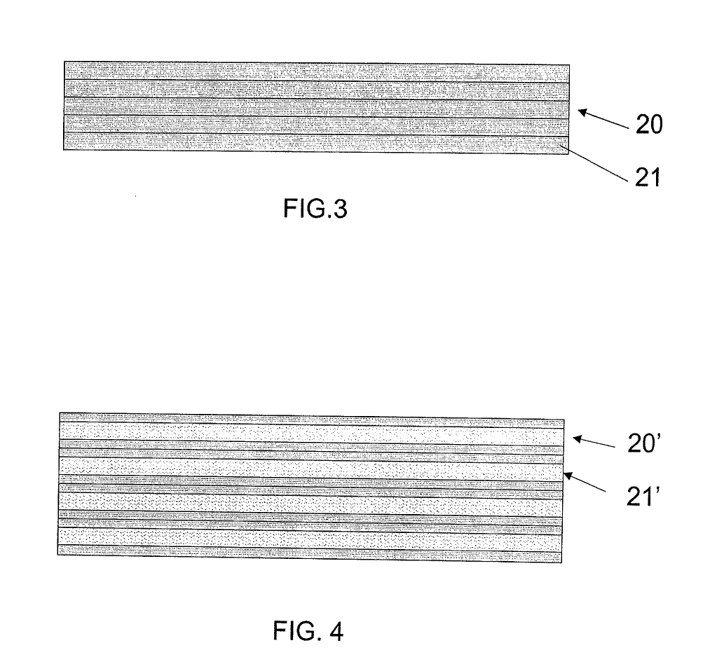

One embodiment of a filtration medium 20 in accordance with the present invention is shown in greater detail in FIG. 3. This filtration medium is readily susceptible to pleating and can be used to form a filter element of the type shown in FIGS. 1 and 2. The filtration medium 20 is of a composite construction and includes a plurality of layers of a liquid permeable nonwoven fabric 21 bonded to one another. The filtration medium 20 has a thickness, basis weight and stiffness that allows for pleating using commercially available pleating processes and machinery, such as rotary and push-bar type pleaters. More particularly, the filtration medium 20 is capable of being formed into sharp creases or folds without loss of strength, and of maintaining its shape in the creased or pleated condition.

The liquid permeable nonwoven fabric 21 includes at least one nonwoven layer formed of continuous filaments. The continuous filament nonwoven fabric layer is a spunbond nonwoven fabric. Examples of various types of processes for producing spunbond fabrics are described in U.S. Pat. No. 3,338,992 to Kinney, U.S. Pat. No. 3,802,817 to Matsuki, U.S. Pat. No. 4,405,297 to Appel, U.S. Pat. No. 4,812,112 to Balk, and U.S. Pat. No. 5,665,300 to Brignola et al. In general, these spunbond processes include steps of extruding molten polymer filaments from a spinneret; quenching the filaments with a flow of air to hasten the solidification of the molten polymer; attenuating the filaments by advancing them with a draw tension that can be applied by either pneumatically entraining the filaments in an air stream or by wrapping them around mechanical draw rolls of the type commonly used in the textile fibers industry; depositing the attenuated filaments randomly onto a collection surface, typically a moving belt, to form a web; and bonding the web of loose filaments. The continuous filaments are bonded to each other at points of contact to impart strength and integrity to the nonwoven web. The bonding can be accomplished by various known means, such as by the use of binder fibers, resin bonding, thermal area bonding, calendering, point bonding, ultrasonic bonding and the like. The filaments are bonded to each other at points of contact, but the nonwoven structure remains sufficiently open to provide the requisite air and water permeability.

In the embodiment shown in FIG. 3, the filtration medium 20 includes five individual layers of a liquid permeable spunbond nonwoven fabric 21 formed from continuous filaments. The layers may be bonded together by various known means as described above. In other embodiments, the liquid permeable nonwoven fabric 21 may additionally include at least one nonwoven fabric layer formed of meltblown fibers. Preferably, the meltblown fibers have a diameter not exceeding 20 μm so that the meltblown nonwoven layer forms a fine pored filtration layer. In one advantageous embodiment, the meltblown fibers are formed from polypropylene and the layer has a basis weight of from 5 to 100 gsm.

In one advantageous embodiment, the liquid permeable nonwoven fabric is a composite nonwoven fabric, and in a more specific embodiment, each layer of the composite nonwoven fabric comprises a spunbond-meltblown-spunbond (SMS) composite laminate, including outer layers of spunbond nonwoven fabric formed of continuous filaments and at least one interior layer of meltblown microfibers. Exemplary spunbond-meltblown-spunbond composite laminates are described in U.S. Pat. Nos. 4,041,204 and 5,108,827.

Thus, as shown in FIG. 4, the filtration medium 20′ includes four plies of a spunbond-meltblown-spunbond nonwoven fabric laminate 21′. The spunbond and meltblown layers of the composite nonwoven fabric laminate 21′ are bonded to one another at discrete point bond sites, commonly referred to as “point bonding” where the fibers are bonded to one another at discrete spaced apart bond sites, usually produced by a patterned or engraved roll. A preferred point bonding technique is sonic bonding wherein the fibers are bonded to one another at discrete spaced apart bond sites by sonic energy using a sonic horn in combination with a patterned or engraved roll.

Preferably, the spunbond nonwoven fabric layers and the meltblown layers are formed of a synthetic fiber-forming polymer which is hydrophobic in nature. Suitable polymers include polypropylene, polyethylene, polyester, and polyamide. Among the well known synthetic fiber-forming polymers, polyester polymers and copolymers are recognized as being suitable for producing hydrophobic nonwoven webs that are resistant to degradation from chlorine and bromine based chemical used in pool and spa water treatment.

Each layer of composite nonwoven fabric laminate 21′ may have a basis weight of from 10 to 200 grams per square meter (gsm), and more desirably from about 34 to 100 grams per square meter. The continuous filaments of the spunbond nonwoven fabric layers preferably have a denier per filament of approximately 1 to 10 and the filaments can have a cross-section ranging from round to trilobal or quadralobal or can include varying cross-sections and varying deniers. In some embodiments, at least one of the spunbond nonwoven layers of the composite nonwoven fabric laminate includes sheath-core bicomponent filaments. The sheath component of the sheath-core bicomponent filaments may suitably be formed from a lower melting polymer than the core component. For example, the core component may be formed from polypropylene and the sheath component from polyethylene. Optionally, an antimicrobial agent can be incorporated into the sheath component.

The filtration medium 20, 20′ may suitably comprise from 2 to 15 layers of the nonwoven fabric 21, 21′ that are bonded to one another to form a relatively stiff multi-layer structure. The overall thickness of the filter medium is preferably from 0.1 to 3 mm. The thickness of the filtration medium affects both its filtration characteristics and its pleatability. Too thin a medium will result in the filtration taking place primarily at the fabric surface. The filter will be easier to clean, but it will clog much more quickly. Thicker materials provide some depth filtration along with surface filtration, which will extend the time required between cleanings. Thickness also affects the pleating and the quality of the final pleat, since fabric thickness is directly related to stiffness. Overly thin materials will not have sufficient stiffness to retain a pleat, and the pleats will tend to collapse upon themselves. Overly thick materials are so stiff that they will form poor pleats or will tend to return to the original unpleated configuration.

To assist in achieving the desired stiffness, the filtration medium 20, 20′ may include, in addition to the nonwoven fabric layers 20, 20′, one or more stiffening layers bonded to the layers of composite nonwoven fabric laminate. The stiffening layer may comprise at least one structure selected from the group consisting of spunbond nonwoven fabrics, carded thermal bond nonwovens, carded resin bond nonwovens, hydroentangled nonwovens, scrims, nets and apertured films.

Preferably, the filtration medium includes from 2 to 15 individual layers of composite nonwoven fabric, more desirably 3 to 6 layers. To provide sufficient stiffness for pleating, the overall thickness of the filtration medium is preferably from about 0.1 to about 3 mm, and more desirably from 1 to 2 mm.

The stiffness of the filtration medium may be quantified using industry standard test instruments, such as the Handle-O-Meter which measures flexibility (or conversely for the purposes of the present invention, stiffness) of sheet materials such as nonwovens in accordance with ASTM D 2923 or the Association of the Nonwovens Fabrics Industry (INDA) standard test method IST 90.3. Handle-O-Meter measurements are made on an instrument by the Thwing-Albert Instrument Co. of Philadelphia. The measurements are the force in grams to push a 100 mm wide fabric into a slot which is 100 mm wide. In conducting the Handle-O-Meter measurements, the fabric is tested from both the top and the bottom and in both the machine direction and the cross direction and the results are averaged. The filtration medium 20 preferably has a Handle-O-Meter stiffness of at least 5 grams, and more desirably at least 10 grams, and for certain applications more desirably at least 18 grams.

The permeability of the nonwoven fabric substrate may be conveniently evaluated by measuring its air permeability using a commercially available air permeability instrument, such as the Textest air permeability instrument, in accordance with the air permeability test procedures outlined in ASTM test method D-1117. Preferably, the nonwoven fabric substrate should have an air permeability, as measured by this procedure, of from 20 to 270.

### EXAMPLES

The following non-limiting examples are provided for purposes of illustrating various embodiments of the present invention.

### Example 1

A composite nonwoven fabric laminate is produced on an integrated spunbond-meltblown-spunbond manufacturing line having successively arranged melt extrusion beams for producing a first spunbond nonwoven outer layer, up to three nonwoven intermediate layers of meltblown microfibers, and a second spunbond nonwoven outer layer. Patterned calender rolls are provided downstream from the last spunbond extrusion beam for bonding the respective layers together to form an integral point bonded nonwoven fabric laminate. The spunbond outer layers each have a basis weight of 10 gsm and are formed of polypropylene continuous filaments. Three intermediate layers of polypropylene meltblown microfibers are produced having a total basis weight of 34 gsm. The resulting spunbond-meltblown-meltblown-meltblown-spunbond (SMMMS) laminate has an overall basis weight of 88 grams per square meter (2.6 ounces per square yard), a thickness of 0.4 mm and a stiffness of 55 grams when tested on a Handle-O-Meter according to IST 90.3 (95).

### Example 2

Seven layers of the composite nonwoven fabric laminate of Example 1 are stacked together face-to-face relation and bonded together by a sonic bonding apparatus. Here, sonic energy is used to generate discrete point bonds from a highly engraved roll to form a pleatable composite laminated filtration medium.

### Example 3

To provide further stiffness to the filtration medium, a 57 grams per square meter polypropylene spunbond nonwoven fabric produced by BBA Fiberweb under the trademark Typar® is placed on one side of the seven-layer laminate of Example 2 and sonic bonded to the seven-layer laminate.

### Example 4

A stiffened filtration medium is produced as in Example 3, except that the Typar® nonwoven stiffening member is replaced by an open-mesh scrim netting of polypropylene produced by Conwed Plastics of Minneapolis, Minn.

### Example 5

The filtration medium of Example 3 is pleated with a push-bar type pleater to form one inch pleats, and the pleated filtration medium is formed into a cylindrical filter cartridge of the configuration shown in FIG. 1 fitted with end caps at each end.

### Example 6

A spunbond nonwoven fabric of 34 grams per square meter basis weight is formed from polypropylene continuous filaments of 1 to 2 denier per filament. The nonwoven fabric is point bonded using an engraved calender roll with a 20 percent bond area. Ten layers of the spunbond nonwoven fabric are stacked together face-to-face along with a polypropylene open-mesh scrim netting on one side. This assembly is sonic bonded together using a sonic bonding apparatus as described in Example 2 to form a pleatable filtration medium. This filtration medium is pleated and formed into a cylindrical filter cartridge of the configuration shown in FIG. 1 with end caps at each end.

### Example 7

Five layers of the SMMMS laminate of Example 1 are combined as the center component of a filtration medium along with outer layers formed of 34 gsm spunbond nonwoven fabric formed of sheath-core bicomponent filaments having a polyethylene sheath and a PET core. The respective layers are sonic bonded together.

### Example 8

A filtration medium is produced as in Example 7, except that a triclosan antimicrobial agent from Microban Inc. is blended into the polyethylene sheath component of the bicomponent fibers at a concentration of 2% by weight of the polyethylene.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A filter cartridge comprising a filter medium including a plurality of layers of a spunbond nonwoven fabric of continuous filaments, the layers being bonded together and formed into a pleated configuration.

2. The filter cartridge of claim 1, wherein the filter medium includes from 2 to 15 layers of the spunbond nonwoven fabric.

3. The filter cartridge of claim 2, wherein the overall thickness of the filter medium is from 0.1 to 3 mm.

4. The filter cartridge of claim 1, wherein the filter medium has a Handle-O-Meter stiffness value of at least 10 grams.

5. The filter cartridge of claim 1, additionally including least one nonwoven layer of meltblown fibers.

6. The filter cartridge of claim 5, wherein the spunbond nonwoven fabric layer and the at least one layer of meltblown fibers form a composite nonwoven fabric laminate.

7. A filter cartridge comprising a filter medium including a plurality of layers of a composite nonwoven fabric laminate, said nonwoven fabric laminate including at least one spunbond layer and at least one meltblown layer, the layers of composite nonwoven fabric laminate being bonded together and formed into a pleated configuration.

8. The filter cartridge of claim 7, wherein the composite nonwoven fabric laminate is a spunbond-meltblown-spunbond composite nonwoven fabric laminate including outer spunbond layers formed of continuous filaments bonded to one another to form a spunbond nonwoven fabric and at least one interior layer of meltblown fibers between said outer spunbond layers.

9. The filter cartridge of claim 8, wherein the outer spunbond layers and the at least one interior layer of meltblown fibers are point-bonded and include discrete point bond sites bonding the outer spunbond layers to form a strong coherent laminate.

10. The filter cartridge of claim 9, wherein the respective layers of composite nonwoven fabric laminate are bonded together by ultrasonic welding.

11. The filter cartridge of claim 7, wherein the filter medium has a Handle-O-Meter stiffness value of at least 18 grams.

12. The filter cartridge of claim 7, wherein each layer of composite nonwoven fabric laminate has a basis weight of from 10 to 200 grams per square meter.

13. The filter cartridge of claim 7, additionally including a stiffening layer bonded to said plurality of layers of composite nonwoven fabric laminate, the stiffening layer comprising at least one structure selected from the group consisting of spunbond nonwoven fabrics, scrims, nets and apertured films.

14. The filter cartridge of claim 7, wherein at least one of the layers of composite nonwoven fabric laminate includes sheath-core bicomponent filaments including a polyethylene sheath component.

15. The filter cartridge of claim 7, wherein at least one of the layers of composite nonwoven fabric laminate includes an antimicrobial agent.

16. A composite filtration medium for liquids, comprising a plurality of layers of a composite nonwoven fabric laminate, said nonwoven fabric laminate including at least one spunbond layer and at least one layer selected from meltblown fibers and cotton fibers, the layers of composite nonwoven fabric laminate being bonded together to provide a pleatable filtration medium.

17. The filtration medium of claim 16, wherein the medium includes from 2 to 15 layers of the composite nonwoven fabric laminate.

18. The filtration medium of claim 17, having an overall thickness from 0.1 to 3 mm.

19. The filtration medium of claim 16, wherein the composite nonwoven fabric laminate is a spunbond-meltblown-spunbond composite nonwoven fabric laminate including outer spunbond layers formed of continuous filaments bonded to one another to form a spunbond nonwoven fabric and at least one interior layer of meltblown fibers between said outer spunbond layers.

20. The filtration medium of claim 19, wherein the outer spunbond layers and the at least one interior layer of meltblown fibers are point-bonded and include discrete point bond sites bonding the outer spunbond layers to form a strong coherent laminate.

21. The filtration medium of claim 19, wherein at least one of the spunbond-meltblown-spunbond composite nonwoven fabric laminates includes continuous filaments of a trilobal cross-section.

22. The filtration medium of claim 16, wherein the medium has a Handle-O-Meter stiffness value of at least 10 grams.

23. A composite filtration medium for liquids, comprising from 2 to 15 layers of a spunbond-meltblown-spunbond composite nonwoven fabric laminate, the spunbond-meltblown-spunbond composite nonwoven fabric laminate including outer spunbond layers formed of continuous filaments bonded to one another to form a spunbond nonwoven fabric and at least one interior layer of meltblown fibers between said outer spunbond layers, and wherein the layers of spunbond-meltblown-spunbond composite nonwoven fabric laminate are bonded together to provide a pleatable filtration medium with a Handle-O-Meter stiffness value of at least 18 grams.

24. The filtration medium of claim 23, wherein the respective layers of composite nonwoven fabric laminate are bonded together by ultrasonic welding.

25. The filtration medium of claim 23, wherein each layer of composite nonwoven fabric laminate has a basis weight of from 10 to 200 grams per square meter.

26. The filtration medium of claim 23, additionally including a stiffening layer bonded to said plurality of layers of composite nonwoven fabric laminate, the stiffening layer comprising at least one structure selected from the group consisting of spunbond nonwoven fabrics, carded thermal bond nonwovens, carded resin bond nonwovens, hydroentangled nonwovens, scrims, nets and apertured films.

27. The filtration medium cartridge of claim 23, wherein at least one of the spunbond layers includes sheath-core bicomponent filaments including a polyethylene sheath component.

28. The filtration medium of claim 27, wherein the polyethylene sheath component includes an antimicrobial agent.
